(19) United States
(12) Patent Application Publication
(10) Pub. No.: US 2022/0361191 A1
(43) Pub. Date: Nov. 10, 2022

(54) COMMUNICATIONS DEVICE, INFRASTRUCTURE EQUIPMENT AND METHODS

(71) Applicant: Sony Group Corporation, Tokyo (JP)

(72) Inventors: Yassin Aden AWAD, Basingstoke (GB); Vivek SHARMA, Basingstoke (GB); Shin Horng WONG, Basingstoke (GB); Martin Warwick BEALE, Basingstoke (GB); Kazuyuki SHIMEZAWA, Basingstoke (GB)

(73) Assignee: Sony Group Corporation, Tokyo (JP)

(21) Appl. No.: 17/762,745

(22) PCT Filed: Sep. 11, 2020
(86) PCT No.: PCT/EP2020/075573

§ 371 Date: Mar. 23, 2022

(30) Foreign Application Priority Data
Oct. 2, 2019 (EP) 19201206.0

(51) Int. Cl. H04W 72/12; H04W 72/14

(52) U.S. Cl. CPC H04W 72/1242; H04W 72/14

(57) ABSTRACT

A method of transmitting data by a communications device in a wireless communications network, the method comprising determining that first data having a first priority is available for transmission, selecting first uplink communications resources for transmission associated with the first data, determining second uplink communications resources allocated for transmitting second data associated with a second priority and one or more parameters for the transmission of the second data using the second uplink communications resources, after the determining that the first data is available for transmission and the selecting the first uplink communications resources, determining based on the first uplink communications resources that the second uplink communications resources cannot be used for the transmission of the second data, storing the one or more parameters, transmitting the transmission associated with the first data using the first uplink communications resources and refraining from transmitting the second data using the second uplink communications resources.

### BACKGROUND

### Field

The present disclosure relates to communications devices, infrastructure equipment and methods for the transmission of data by a communications device in a wireless communications network.

The present application claims the Paris convention priority from European patent application EP19201206.0, the contents of which are incorporated herein by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Third and fourth generation mobile telecommunication systems, such as those based on the 3GPP defined UMTS and Long Term Evolution (LTE) architecture, are able to support more sophisticated services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, may be expected to increase ever more rapidly.

Future wireless communications networks will be expected to support communications routinely and efficiently with a wider range of devices associated with a wider range of data traffic profiles and types than current systems are optimised to support. For example it is expected future wireless communications networks will be expected to efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance.

In view of this there is expected to be a desire for future wireless communications networks, for example those which may be referred to as 5G or new radio (NR) system/new radio access technology (RAT) systems [1], as well as future iterations/releases of existing systems, to efficiently support connectivity for a wide range of devices associated with different applications and different characteristic data traffic profiles.

An example of such a new service is referred to as Ultra Reliable Low Latency Communications (URLLC) services which, as its name suggests, requires that a data unit or packet be communicated with a high reliability and with a low communications delay. URLLC type services therefore represent a challenging example for both LTE type communications systems and 5G/NR communications systems.

The increasing use of different types of communications devices associated with different traffic profiles gives rise to new challenges for efficiently handling communications in wireless telecommunications systems that need to be addressed.

### SUMMARY

The present disclosure can help address or mitigate at least some of the issues discussed above.

Embodiments of the present technique can provide a method of transmitting data by a communications device in a wireless communications network. The method comprises determining that first data having a first priority is available for transmission by the communications device, selecting first uplink communications resources for a transmission associated with the first data, determining second uplink communications resources allocated for transmitting second data associated with a second priority and one or more parameters for the transmission of the second data using the second uplink communications resources, the second priority being lower than the first priority, after the determining that the first data is available for transmission and the selecting the first uplink communications resources, determining based on the first uplink communications resources that the second uplink communications resources cannot be used for the transmission of the second data, storing the one or more parameters, transmitting the transmission associated with the first data using the first uplink communications resources and refraining from transmitting the second data using the second uplink communications resources, receiving an uplink grant, the uplink grant comprising an indication of third uplink communications resources allocated for transmitting the data having the second priority, and transmitting the second data using the third uplink communications resources in accordance with the stored one or more parameters.

Embodiments of the present technique, which further relate to communications devices, methods of operating communications devices and infrastructure equipment and circuitry for communications devices and infrastructure equipment, allow for predictable and consistent behaviour by the communications device in scenarios in which multiple colliding communications resources are allocated for the transmission of data by the communications device, resulting in the communications device not being able to transmit data using allocated resources.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured in accordance with example embodiments;

FIG. 4 illustrates by means of a message sequence chart a series of transmissions between a communications device and an infrastructure equipment in accordance with conventional techniques;

FIG. 5 illustrates by means of a combined message sequence chart/process flow chart transmissions between the communications device and the infrastructure equipment according to embodiments of the present technique;

FIG. 6 illustrates a flow chart for a process for a communications device in accordance with embodiments of the present technique;

FIG. 7 illustrates by means of a combined message sequence chart/process flow chart transmissions between the communications device and the infrastructure equipment according to embodiments of the present technique; and

FIG. 8 illustrates a flow chart for a process for a communications device in accordance with embodiments of the present technique.

### DETAILED DESCRIPTION OF THE EMBODIMENTS

Long Term Evolution Advanced Radio Access Technology (4G)

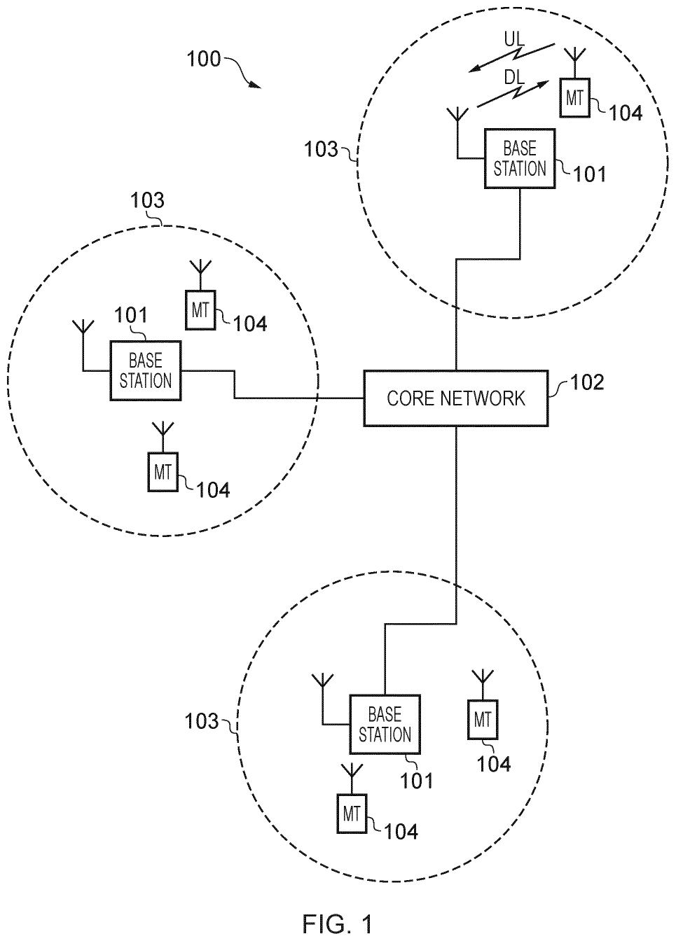

FIG. 1 provides a schematic diagram illustrating some basic functionality of a mobile telecommunications network/system 100 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP® body, and also described in many books on the subject, for example, Holma H. and Toskala A [2]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 100 includes a plurality of base stations 101 connected to a core network part 102. Each base station provides a coverage area 103 (e.g. a cell) within which data can be communicated to and from communications devices 104. Data is transmitted from the base stations 101 to the communications devices 104 within their respective coverage areas 103 via a radio downlink Data is transmitted from the communications devices 104 to the base stations 101 via a radio uplink. The core network part 102 routes data to and from the communications devices 104 via the respective base stations 101 and provides functions such as authentication, mobility management, charging and so on. Communications devices may also be referred to as mobile stations, user equipment (UE), user terminals, mobile radios, terminal devices, and so forth. Base stations, which are an example of network infrastructure equipment/network access nodes, may also be referred to as transceiver stations/nodeBs/e-nodeBs, g-nodeBs (gNB) and so forth. In this regard different terminology is often associated with different generations of wireless telecommunications systems for elements providing broadly comparable functionality. However, example embodiments of the disclosure may be equally implemented in different generations of wireless telecommunications systems such as 5G or new radio as explained below, and for simplicity certain terminology may be used regardless of the underlying network architecture. That is to say, the use of a specific term in relation to certain example implementations is not intended to indicate these implementations are limited to a certain generation of network that may be most associated with that particular terminology.

New Radio Access Technology (5G)

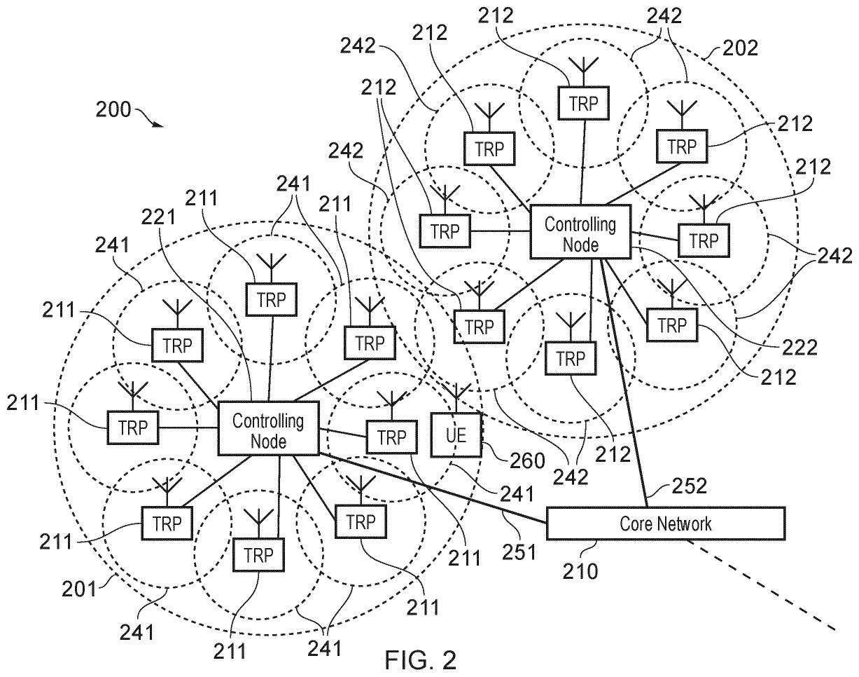

FIG. 2 is a schematic diagram illustrating a network architecture for a new RAT wireless communications network/system 200 based on previously proposed approaches which may also be adapted to provide functionality in accordance with embodiments of the disclosure described herein. The new RAT network 200 represented in FIG. 2 comprises a first communication cell 201 and a second communication cell 202. Each communication cell 201, 202, comprises a controlling node (centralised unit) 221, 222 in communication with a core network component 210 over a respective wired or wireless link 251, 252. The respective controlling nodes 221, 222 are also each in communication with a plurality of distributed units (radio access nodes/remote transmission and reception points (TRPs)) 211, 212 in their respective cells. Again, these communications may be over respective wired or wireless links. The distributed units 211, 212 are responsible for providing the radio access interface for communications devices connected to the network. Each distributed unit 211, 212 has a coverage area (radio access footprint) 241, 242 where the sum of the coverage areas of the distributed units under the control of a controlling node together define the coverage of the respective communication cells 201, 202. Each distributed unit 211, 212 includes transceiver circuitry for transmission and reception of wireless signals and processor circuitry configured to control the respective distributed units 211, 212.

In terms of broad top-level functionality, the core network component 210 of the new RAT communications network represented in FIG. 2 may be broadly considered to correspond with the core network 102 represented in FIG. 1, and the respective controlling nodes 221, 222 and their associated distributed units/TRPs 211, 212 may be broadly considered to provide functionality corresponding to the base stations 101 of FIG. 1. The term network infrastructure equipment/access node may be used to encompass these elements and more conventional base station type elements of wireless communications systems. Depending on the application at hand the responsibility for scheduling transmissions which are scheduled on the radio interface between the respective distributed units and the communications devices may lie with the controlling node/centralised unit and/or the distributed units/TRPs.

A communications device or UE 260 is represented in FIG. 2 within the coverage area of the first communication cell 201. This communications device 260 may thus exchange signalling with the first controlling node 221 in the first communication cell via one of the distributed units 211 associated with the first communication cell 201. In some cases communications for a given communications device are routed through only one of the distributed units, but it will be appreciated that in some other implementations communications associated with a given communications device may be routed through more than one distributed unit, for example in a soft handover scenario and other scenarios.

In the example of FIG. 2, two communication cells 201, 202 and one communications device 260 are shown for simplicity, but it will of course be appreciated that in practice the system may comprise a larger number of communication cells (each supported by a respective controlling node and plurality of distributed units) serving a larger number of communications devices.

It will further be appreciated that FIG. 2 represents merely one example of a proposed architecture for a new RAT communications system in which approaches in accordance with the principles described herein may be adopted, and the functionality disclosed herein may also be applied in respect of wireless communications systems having different architectures.

Thus example embodiments of the disclosure as discussed herein may be implemented in wireless telecommunication systems/networks according to various different architectures, such as the example architectures shown in FIGS. 1 and 2. It will thus be appreciated that the specific wireless communications architecture in any given implementation is not of primary significance to the principles described herein. In this regard, example embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type infrastructure equipment 101 as shown in FIG. 1 which is adapted to provide functionality in accordance with the principles described herein, and in other examples the network infrastructure equipment/access node may comprise a control unit/controlling node 221, 222 and/or a TRP 211, 212 of the kind shown in FIG. 2 which is adapted to provide functionality in accordance with the principles described herein.

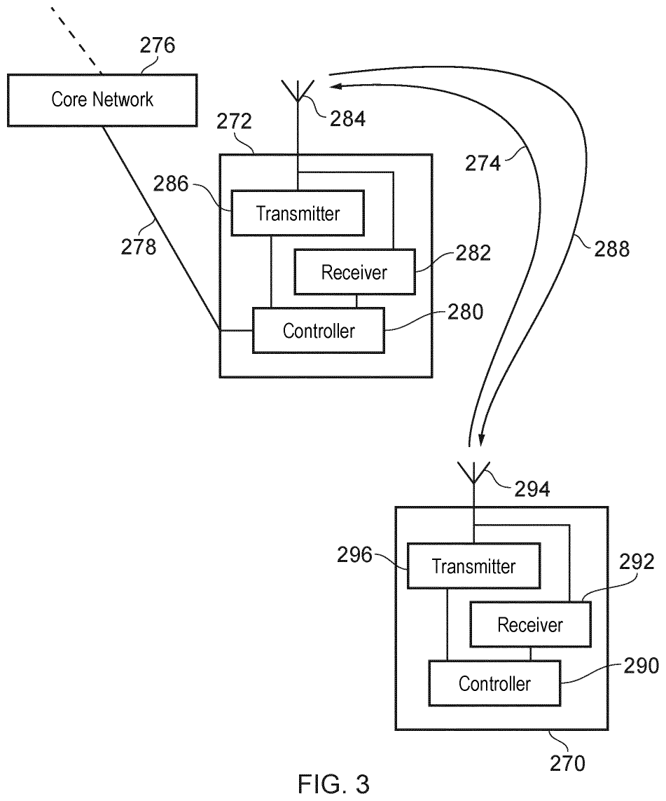

A more detailed illustration of a UE/communications device 270 (which may correspond to a communications device such as the communications device 260 of FIG. 2 or the communications device 104 of FIG. 1) and an example network infrastructure equipment 272, which may be thought of as a base station 101 or a combination of a controlling node 221 and TRP 211, is presented in FIG. 3. As shown in FIG. 3, the UE 270 is shown to transmit uplink data to the infrastructure equipment 272 via uplink resources of a wireless access interface as illustrated generally by an arrow 274 from the UE 270 to the infrastructure equipment 272. The UE 270 may similarly be configured to receive downlink data transmitted by the infrastructure equipment 272 via downlink resources as indicated by an arrow 288 from the infrastructure equipment 272 to the UE 270. As with FIGS. 1 and 2, the infrastructure equipment 272 is connected to a core network 276 via an interface 278 to a controller 280 of the infrastructure equipment 272. The infrastructure equipment 272 includes a receiver 282 connected to an antenna 284 and a transmitter 286 connected to the antenna 284. Correspondingly, the UE 270 includes a controller 290 connected to a receiver 292 which receives signals from an antenna 294 and a transmitter 296 also connected to the antenna 294.

The controller 280 is configured to control the infrastructure equipment 272 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 280 may comprise circuitry which is suitably configured/programmed to provide the desired functionality using conventional programming/configuration techniques for equipment in wireless telecommunications systems. The transmitter 286 and the receiver 282 may comprise signal processing and radio frequency filters, amplifiers and circuitry in accordance with conventional arrangements. The transmitter 286, the receiver 282 and the controller 280 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment 272 will in general comprise various other elements associated with its operating functionality.

Correspondingly, the controller 290 of the UE 270 is configured to control the transmitter 296 and the receiver 292 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 290 may comprise circuitry which is suitably configured/programmed to provide the desired functionality using conventional programming/configuration techniques for equipment in wireless telecommunications systems. Likewise, the transmitter 296 and the receiver 292 may comprise signal processing and radio frequency filters, amplifiers and circuitry in accordance with conventional arrangements. The transmitter 296, receiver 292 and controller 290 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the communications device 270 will in general comprise various other elements associated with its operating functionality, for example a power source, user interface, and so forth, but these are not shown in FIG. 3 in the interests of simplicity.

The controllers 280, 290 may be configured to carry out instructions which are stored on a computer readable medium, such as a non-volatile memory. The processing steps described herein may be carried out by, for example, a microprocessor in conjunction with a random access memory, operating according to instructions stored on a computer readable medium.

5G, URLLC and Industrial Internet of Things

Systems incorporating NR technology are expected to support different services (or types of services), which may be characterised by different requirements for latency, data rate and/or reliability. For example, Enhanced Mobile Broadband (eMBB) services are characterised by high capacity with a requirement to support up to 20 Gb/s. The requirements for Ultra Reliable & Low Latency Communications (URLLC) services are for a reliability of 1-10⁻⁵ (99.999%) or higher for one transmission of a 32 byte packet with a user plane latency of 1 ms [3]. In some scenarios, there may be a requirement for a reliability of 1-10⁻⁶ (99.9999%) or higher with either 0.5 ms or 1 ms of user plane latency. Massive Machine Type Communications (mMTC) is another example of a service which may be supported by NR-based communications networks.

In addition, systems may be expected to support further enhancements related to Industrial Internet of Things (IIoT) in order to support services with new requirements of high availability, high reliability, low latency, and in some cases, high-accuracy positioning.

Industrial automation, energy power distribution and intelligent transport systems are examples of new use cases for Industrial Internet of Things (IIoT). In an example of industrial automation, the system may involve different distributed components working together. These components may include sensors, virtualized hardware controllers and autonomous robots, which may be capable of initiating actions or reacting to critical events occurring within a factory and communicating over a local area network.

The UEs in the network may therefore be expected to handle a mixture of different traffic, for example, associated with different applications and potentially different quality of service requirements (such as maximum latency, reliability, packet sizes, throughput). Some messages for transmission may be time sensitive and be associated with strict deadlines and the communications network may therefore be required to provide time sensitive networking (TSN) [6][9]. Examples of different types of traffic that a single UE may be required to support include:
Multiple periodic streams, of different periodicities, of different priorities, for example multiple streams coming from different applications
Aperiodic critical priority traffic that is the result of critical events, like alarms, safety detectors that need to rapidly communicate information about the occurrence of a critical event
Best effort type of traffic such as eMBB traffic, internet traffic, or any other traffic supporting factory operations.

URLLC services are required in order to meet the requirements for IIoT, which require high availability, high reliability, low latency, and in some cases, high-accuracy positioning W. Some IIoT services may be implemented by using a mixture of eMBB and URLLC techniques, where some data is transmitted by eMBB and other data is transmitted by URLLC.

There is thus a requirement for a communications device to be able to efficiently transmit data associated with different applications and/or requirements.

Uplink Grants

Uplink data is typically transmitted on communications resources which are allocated to the communications device by the network, for example by the infrastructure equipment 101. The allocation of communications resources is referred to herein as an uplink grant.

Dynamic grants and configured grants are examples of uplink grants. A dynamic uplink grant is transmitted in response to an explicit indication from the communications device that it has data available to be transmitted. The indication may be, for example, a buffer status report (BSR) or a scheduling request (SR).

A configured grant may allocate communications resources whether or not, at the time of the grant, there is data available for transmission using the granted resources. In particular, a configured grant may provide one or more instances of communications resources, which may be particularly suitable for the transmission of data which is known to be generated periodically. Thus, even though at the time of the grant, the data is not available for transmission, it is known (or likely) that data will become available for transmission using each instance of the allocated resources, as they arise.

A configured grant can be more efficient, because only one signalling message is required to allocate a large number of instances of communications resources over a period of time. In contrast, because a dynamic grant is responsive to a specific indication of available data, it can ensure that all allocated uplink communications resources will be used for the transmission of data. A dynamic grant may also provide a lower latency for transmissions, depending on the periodicity of the configured grant resource instances.

Signalling of a dynamic grant may comprise indications of one or more of the following:
Resource allocation: Frequency-domain resource blocks (RBs) and time-domain allocation
Transport block-related (TB): Modulation and coding scheme (MCS), e.g. a modulation (e.g. QPSK, 16QAM) and a coding rate (which may indicate a ratio of an amount of information bits to a total number of bits that are transmitted), New data indicator (NDI), Redundancy version (RV)
Hybrid automatic repeat request (HARQ)-related: Process number, etc.
Multiple-antenna-related: DMRS, Antenna ports, Precoding information, PTRS, SRS, etc.
Power control: power control for PUSCH, Beta-offset

The number of bits of data to be encoded within a transport block (i.e. the transport block size, TBS) may not be explicitly signalled, but may be derived based on the indicated MCS and the extent of the resource allocation (e.g. the number of resource elements (REs) allocated for PUSCH). For retransmissions, if the coding rate is not explicitly indicated in the signaled MCS, the TBS in the first transmission is used if the TB was built during the first transmission.

New Data Indicator

An uplink grant may comprise an indication of a new data indicator (NDI), which may be accompanied by a HARQ process identifier. The NDI associated with a particular HARQ process may be toggled so that its value differs from that in a most recent previous grant associated with the particular HARQ process, to indicate that data previously associated with that HARQ process is not to be retransmitted (or to form the basis of any further transmission) and that any stored data which is already associated with that HARQ process is to be discarded. This may be because a previous data transmission associated with the HARQ process has been correctly received at the infrastructure equipment, or because the infrastructure equipment does not require the communications device to retransmit the data for any other reason. The toggling of the NDI associated with a HARQ process may therefore indicate that the present grant should therefore be used for a first transmission of new data.

Thus conventionally, the communications device is expected to flush any buffers of data associated with the HARQ process so that no further transmission of that data occurs, in response to receiving a grant for a HARQ process where the NDI is toggled. In particular, any PDU stored in a buffer associated with that HARQ process can be discarded, since the conventional purpose of storing a PDU in a HARQ buffer is to allow retransmissions in case the data was not correctly received. The HARQ process may then be used for the transmission of further data.

For a configured grant, the scheduling information may be similar to that for a dynamic grant, but may also include a periodicity of the allocated resource instances. A configured grant may be provided in advance via radio resource control (RRC) signalling, or a combination of dynamic and RRC signalling. The communications device stores this scheduling information after such a configuration.

An uplink grant may be associated with a particular logical channel or logical channel priority. Data for transmission may be associated with one of a plurality of logical channels, each associated with quality of service requirements, including a logical channel priority. For example, a configured grant may allocate resources for the transmission of data associated with a particular logical channel.

Thus, a communications device may receive multiple uplink grants, which provide communications resources for the transmission of data associated with respective logical channels, or logical channel priorities.

A dynamic grant may allocate communications resources for the transmission of data, without explicit restriction as to the logical channel or logical channel priority of the data. However, a dynamic grant may be transmitted in response to a request (e.g. a Scheduling Request, SR) by the communications device for communications resources for the transmission of data, the data being associated with a particular logical channel or logical channel priority. Therefore, although a dynamic grant may not comprise an indication of a particular logical channel or logical channel priority, in the present description for clarity a dynamic grant may be described as being associated with a particular logical channel or logical channel priority, based on the data which triggered the request for the dynamic grant.

Collision

In some cases, communications resources allocated by two or more uplink grants may not be compatible with each other. That is, it may not be possible for the communications device to transmit data using all of the allocated resources. For example, the resources may overlap in time, or in time and frequency. Additionally or alternatively, communications resources may collide if they are separated in time by less than a predetermined duration and/or if they are overlapping in time and span a frequency range greater than a predetermined threshold (i.e. the difference in frequency between a lowest frequency used by either of the communications resources and a highest frequency used by either of the communications resources exceeds the predetermined threshold), and/or if the resources are within different frequency bands. Such a scenario is referred to as a collision.

In accordance with conventional standards, such as those specified by 3GPP for Release 15 of the New Radio (NR) standards, in the event of a collision between resources allocated by a dynamic grant, and those allocated by a configured grant, the dynamic grant resources take precedence, and no data is transmitted using the configured grant resources.

However, it is has been proposed that this rule is restrictive and inappropriate. For example, a configured grant may be associated with high priority and/or low latency data (or a corresponding logical channel or logical channel priority). It may be the case, for example, that urgent data relating to an equipment control application is generated at a known periodicity and that resources for the uplink transmission of this data are provided by means of a configured grant. A dynamic grant, on the other hand, may be for a large quantity of communications resources for a high bandwidth application which can tolerate some latency in the uplink transmission. If the dynamic grant resources were to collide with, and pre-empt, the configured grant resources, then the urgent data may be unacceptably delayed.

Accordingly, it has been proposed that, in the event of a collision, the precedence of uplink communications resources is determined by reference to a priority of a logical channel associated with the data to be transmitted using the respective resources.

The present disclosure addresses problems arising from a collision of communications resources which result in a subsequent allocation of resources for the retransmission of data which was not transmitted as a result of the collision.

In particular, the disclosure addresses scenarios in which an uplink grant is received and the communications device determines based on the uplink grant that both i) the uplink grant allocates resources which collide with other allocated uplink resources and ii) that the uplink grant allocates resources for the transmission of data having a lower priority than other data or uplink control information (e.g. Scheduling Request) which is to be transmitted using the other allocated uplink resources.

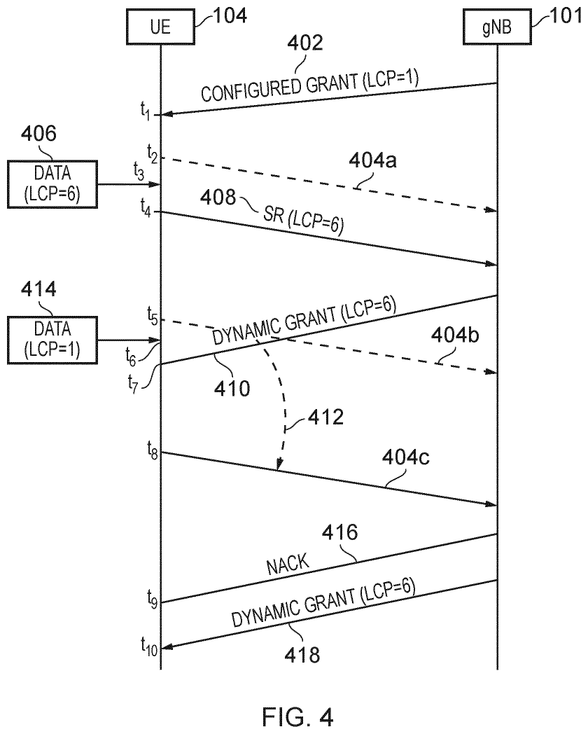

An example of such a scenario is illustrated in FIG. 4.

FIG. 4 illustrates a scenario in which embodiments of the present technique may be used to address a collision situation. FIG. 4 illustrates transmissions between a communications device 104 and an infrastructure equipment 101. Time progresses from top to bottom.

Initially at time T1, the communications device 104 receives a configured grant 402 indicating communication resources for the transmission of uplink data associated with a logical channel priority (LCP) of 1. The uplink communication resources 404a, 404b and 404c are at times T2, T5 and T8 respectively.

In the scenario in FIG. 4, the communications device 104 does not have any available data for transmission at time T2, and thus the communications resources 404a go unused. Similarly, no data having LCP equal to 1 is available for transmission prior to time T5, and the second communication resources 404b also go unused.

At time T3, data associated with a logical channel priority of 6 becomes available for uplink transmission at the communication device 104, indicated by box 406. Because there are no allocated resources for the transmission of this data, then in response to the data becoming available, the communications device 104 transmits at time T4 a scheduling request 408 to the infrastructure equipment 101 requesting uplink communication resources for the transmission of data with a logical channel priority of 6.

In response to receiving the scheduling request 408, the infrastructure equipment 101 transmits an uplink grant 410 to the communications device 104 allocating uplink communication resources for the transmission of data with a logical channel priority of 6. As indicated by the dashed arrow 412, the communication resources allocated by the uplink grant 410 coincide with the communication resources 404c allocated by the configured grant 402. The uplink grant 410 is received by the communications device 104 at time T7.

Prior to time T7, at time T6 data associated with LCP=1 becomes available for uplink transmission at the communications device 104, as indicated by the box 414. It is determined that the data with LCP=1 and data with LCP=6 cannot both be transmitted using the respective allocated communication resources at time T8. In particular, at time T7, in response to receiving the uplink grant 410, the communications device 104 determines that the communication resources allocated by the uplink grant 410 collide with the communication resources 404c allocated by the configured grant 402.

In accordance with the proposed prioritization rules for handling data in such scenarios as described above, the communications device determines that the data having LCP=6 and therefore being of lower priority than the data having LCP=1, is not to be transmitted at time T8. Accordingly, at time T8, the communications device 104 transmits the uplink data having LCP=1. It refrains from transmitting at time T8 the data having LCP=6.

The infrastructure equipment 101, determines that no data having LCP=6 was received and correctly decoded using the resources of the uplink grant 410 and in response, transmits a negative acknowledgement 416 to the communications device 104, which arrives at time T9. In addition, the infrastructure equipment 101 transmits a further uplink grant 418 for the re-transmission of the data having LCP=6 which was to have been sent using the resources allocated by the uplink grant 410.

In the example of FIG. 4, the communications resources allocated by the uplink grant 410 collide with communications resources to be used for the transmission of data in accordance with the configured grant 402. However, embodiments of the present technique apply in any scenario where a transmission of low priority data is prevented as a result of a transmission having a higher priority. For example, in some embodiments, the transmission having the higher priority is a scheduling request which requests uplink communications resources for the transmission of the higher priority data, and where the communications resources selected for the transmission of the scheduling request collide with those allocated by an uplink grant for the transmission of lower priority data.

The present disclosure addresses scenarios such as that illustrated in FIG. 4 and described above, particularly in respect of the manner in which the communications device 104 is to re-transmit data for which communication resources have previously been allocated, but have not been used due to a collision with other allocated communication resources.

In a scenario such as shown in FIG. 4, having determined (at or after time t7) that a collision of allocated resources is to occur, and that therefore no data with LCP=6 will be transmitted using the resources allocated by the uplink grant 410, the communications device 104 may discard the uplink grant 410.

However, the inventors of the present disclosure have recognised that this may result in undesirable and so far unforeseen consequences, in particular regarding the use of any subsequent allocation of communications resources where the subsequent allocation is for the transmission of the lower priority data and/or associated with a HARQ process used for the formation of a PDU comprising the lower priority data.

Accordingly, the present disclosure provides methods and apparatus for storing one or more parameters indicated in an uplink grant, even if no data is to be transmitted in accordance with the grant. In embodiments of the present technique, on receiving a subsequent uplink grant for a retransmission of the data which would (absent the collision) have been transmitted using the earlier uplink grant, data is encoded and transmitted using the resources allocated by the subsequent uplink grant, at least one of the encoding and transmitting being in accordance with the stored one or more parameters.

In particular, embodiments of the present disclosure provide a method of transmitting data by a communications device in a wireless communications network. The method comprises determining that first data having a first priority is available for transmission by the communications device, selecting first uplink communications resources for a transmission associated with the first data, determining second uplink communications resources allocated for transmitting second data associated with a second priority and one or more parameters for the transmission of the second data using the second uplink communications resources, the second priority being lower than the first priority, after the determining that the first data is available for transmission and the selecting the first uplink communications resources, determining based on the first uplink communications resources that the second uplink communications resources cannot be used for the transmission of the second data, storing the one or more parameters, transmitting the transmission associated with the first data using the first uplink communications resources and refraining from transmitting the second data using the second uplink communications resources, receiving an uplink grant, the uplink grant comprising an indication of third uplink communications resources allocated for transmitting the data having the second priority, and transmitting the second data using the third uplink communications resources in accordance with the stored one or more parameters.

Techniques in accordance with the present disclosure can ensure that data, which is prevented from being transmitted using particular resources because of a collision with resources allocated for the transmission of higher priority data, can be transmitted using a subsequent allocation of resources in a predictable and reliable manner

Techniques disclosed herein can avoid a need for infrastructure equipment to transmit to a communications device one or more parameters required for a retransmission of data, and may avoid a need for the infrastructure equipment to determine whether a retransmission is required as a result of a collision amongst resources allocated to the same communications device.

The infrastructure equipment may consider, in response to a failure to decode the lower priority data, that no PDU was formed at the communications device. Accordingly, the infrastructure equipment may schedule communications resources for the transmission of new data (e.g. with the NDI toggled). Alternatively, the infrastructure equipment may consider that a PDU was formed, and schedule resources for a “retransmission” of that data (even though the data was not in fact transmitted as a result of the collision).

Similarly, at the communications device, depending on relative timing of communications resource selections and availability of data and other implementation aspects, a PDU may or may not have been formed and buffered, such as in accordance with conventional HARQ procedures. The infrastructure equipment may not be able to determine whether the communications device had generated a PDU and stored it in a HARQ buffer.

These various possibilities can result in inconsistent and/or unpredictable behaviour, which is undesirable. Embodiments of the present technique disclosed herein can avoid such inconsistent and unpredictable behaviour, to ensure reliable and efficient transmission of data in accordance with its associated logical channel priority. In particular, embodiments of the present technique disclosed herein can avoid such inconsistent and unpredictable behaviour without requiring any modification of existing control signalling. Irrespective of any assumptions made by the infrastructure equipment, the techniques disclosed herein can ensure that the communications device behaviour is appropriate, consistent and predictable and does not result in, for example, either discarding of data which has not been transmitted, or an inability to make use of subsequently allocated communications resources.

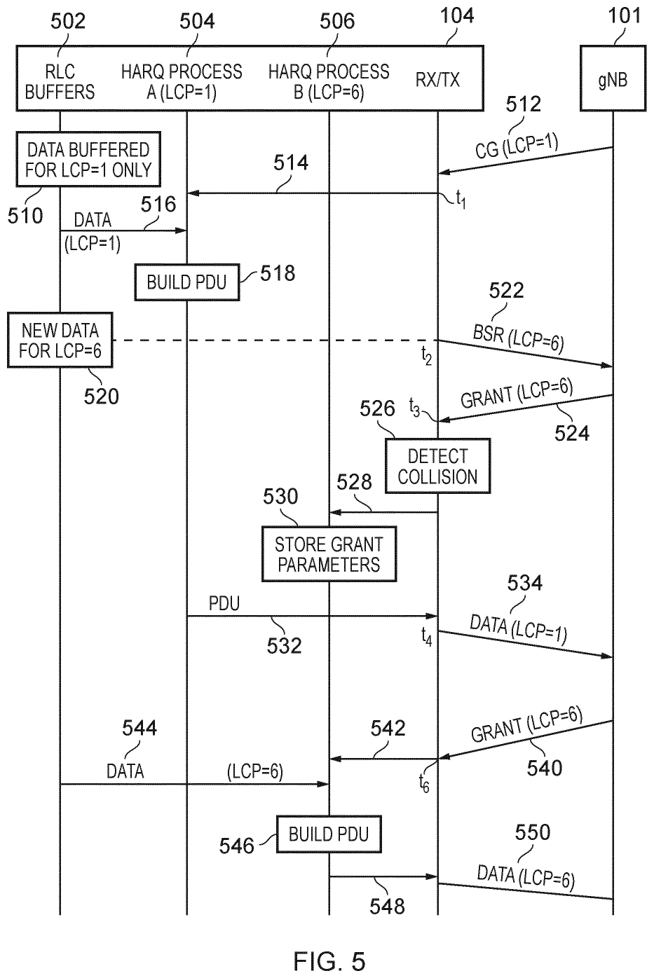

FIG. 5 illustrates a message sequence chart illustrating certain embodiments of the present technique.

FIG. 5 shows transmissions between the communications device 104 and the infrastructure equipment 101 according to embodiments of the present technique. For clarity FIG. 5 shows processes and buffers within the communication device 104. In particular FIG. 5 shows RLC buffers 502, a first HARQ process (HARQ process A) 504 and a second HARQ process (HARQ process B) 506. These buffers and processes are shown for clarity but the scope of the present disclosure is not limited to any particular internal process or storage organisation within the communications device 104. Although in the figures, the HARQ processes A and B 504, 506 are indicated as being associated with particular LCP values, in some embodiments, this relationship is temporary and applicable only while a particular PDU associated with that LCP is being formed and pending confirmation that the PDU has been correctly received by the infrastructure equipment 101. In other words, a particular HARQ process may be used for data having different LCP values from time to time.

Initially, as indicated in box 510, data is buffered in RLC buffers 502 for LCP 1. At time T1, the communications device 104 receives a configured grant allocating uplink communication resources for the transmission of data with LCP=1. Within the communications device 104, this grant is notified to the HARQ process A 504 as indicated by the arrow 514. In response to the notification of the grant, the HARQ process A 504 retrieves data having LCP=1 from the RLC buffers 502 indicated at 516. The HARQ process A 504 then builds a protocol data unit (PDU) or transport block (TB) at 518. The PDU is formed and encoded in accordance with parameters indicated in the configured grant 512.

Subsequently, at 520, the RLC buffers 502 receive new data, for example from an application, for transmission to the infrastructure equipment 101, associated with LCP=6. In response to receiving the new data, the communications device 104 transmits at time T2 a buffer status report (BSR) 522 to the infrastructure equipment 101 requesting uplink communication resources for the transmission of data. The request may be explicitly for resources for the transmission of data with LCP=6. In some embodiments, the association between the request (which may be the BSR 522 or a scheduling request) and the LCP of the data to be transmitted using the resources in response to the request may be implicit, for example, based on communications resources used for the transmission of the BSR or SR being associated with a particular configuration which is associated with a particular logical channel or logical channel priority.

At time t3, the communications device 104 receives an uplink grant 524 allocating uplink communication resources for the transmission of data with LCP=6. In some embodiments, the uplink grant 524 is a dynamic grant. In some embodiments, the uplink grant 524 is a configured grant allocating periodic communications resources.

After time t3, in response to receiving the uplink grant 524, at 526, the communications device 104 determines that the uplink communication resources allocated by the uplink grant 524 collide with communication resources allocated by the configured grant 512. Furthermore, the communications device 104 determines that the collision will be resolved by allowing the transmission of data associated with LCP=1. That is, no data having LCP=6 will be transmitted using the communication resources allocated by the uplink grant 524.

As described above, in some conventional approaches, in response to detecting a collision, the communication device 104 may discard the grant 524. However, in accordance with embodiments of the present technique, at 528 the grant 524 is indicated to a selected HARQ process (in the example of FIG. 5, the HARQ process B 506) which is responsible for the transmission of data having LCP=6. At 530, the HARQ process B 506 stores one or more parameters indicated by the grant 524. The selection of the HARQ process may be based on an indication in the grant 524 of the HARQ process to be used for the transmission of data using the resources allocated by the grant 524.

The communication resources, which are the subject of the collision detected at 526, start at time t4 and accordingly, prior to time t4 at 532, the PDU formed at 518 comprising data having LCP=1 is transferred from the HARQ process A 504 and is transmitted as data 534 to the infrastructure equipment 101. In the example of FIG. 5, it is assumed that the data 534 is received correctly by the infrastructure equipment 101. The transmission of the data 534 may be in accordance with conventional techniques.

After time T4, the infrastructure equipment 101 determines that no data with LCP=6 was transmitted using the uplink communication resources allocated by the grant 524. Alternatively or additionally, the infrastructure equipment 101 may have attempted to decode the data with LCP=6 in accordance with the parameters indicated in the grant 524, and failed to successfully decode any such data. Accordingly, the infrastructure equipment 101 transmits a second uplink grant 540 which is received by the communications device 104 at time t6. The second uplink grant may identify the HARQ process B 506. An indication of the grant is forwarded to the HARQ process B 506 at 542.

In 3GPP NR, a negative acknowledgement indication may be implicit, indicated by the allocation of resources for a retransmission of data, for example as part of the second uplink grant 540.

In some embodiments, the infrastructure equipment 101 transmits an explicit negative acknowledgement indication (not shown) which is received by the communications device 104 and forwarded within the communications device to the HARQ process B 506.

In accordance with embodiments of the present technique, the HARQ process B 506 retrieves, at 544, data from the RLC buffers 502 for building at 546 a PDU or transport block for transmission on the wireless access interface to the infrastructure equipment 101. The forming of the PDU or transport block at 546 is in accordance with one or more parameters which were received in the first uplink grant 524, and which were stored by the HARQ process B 506 at 530. For example, in some embodiments, the stored grant parameters may comprise one or more modulation and coding scheme parameters, which are used to determine a transport block size in accordance with the stored modulation and coding scheme parameters. Subsequently at 548, the constructed PDU or transport block is transferred from the HARQ process B 506 and is transmitted as data 550 to the infrastructure equipment 101.

The infrastructure equipment 101 determines whether the data 550 was received correctly or not and may perform further additional steps, which may be in accordance with conventional HARQ techniques.

In the embodiment illustrated in FIG. 5, the collision arises in respect of communications resources for the transmission of data.

In some embodiments, the collision may arise in respect of communications resources allocated for the transmission of data and communications resources selected for the transmission of control information. In some embodiments, the control information may be associated with data. For example, the control information may be a scheduling request (SR). The control information may, accordingly, be associated with a priority level based on the priority level associated with the data. Herein, accordingly, references to ‘data’, ‘transmission of data’ and the like may refer to ‘transmission associated with the data’, where in some embodiments a priority of the transmission associated with the data is based on a priority associated with the data.

For example, in FIG. 5, the resources allocated by the uplink grant 524 may collide instead with resources selected (for example, on a physical uplink control channel, PUCCH) for the transmission of a scheduling request. The scheduling request resources may have been selected before time t3 when the uplink grant 524 was received.

In response to detecting the collision at 526, the communications device 104 may compare the priority of the data for which the SR is requesting resources and the priority of the data for which the resources are allocated by the uplink grant 524. In an example, the SR is in respect of data with LCP=1, and thus has a higher priority than the data with LCP=6. Accordingly, the communications device 104 may determine that no data with LCP=6 can be transmitted using the resources allocated by the uplink grant 524.

At time t4, the scheduling request is transmitted on the selected communications resources, and the communications device 104 may subsequently receive a response, which may be transmitted in the conventional manner

Steps 528, 530, and the remaining steps relating to the formation of the PDU comprising data with LCP=6 and the transmission of the data with LCP=6 may continue as shown in FIG. 5 and described above.

In the embodiment shown in FIG. 5, the communications device 104 may be unable to form a PDU comprising the lower priority (LCP=6) data prior to the determination of the collision at 526, because that determination may occur only in response to the receipt of the grant 524 which includes the parameters needed to form the PDU.

In some embodiments, the communications device may be unable to form a PDU comprising the lower priority (LCP=6) data prior to the determination of the collision at 526, because the data with LCP=6 to be included in the PDU is not yet available. This may occur in scenarios where the uplink grant 524 is received prior to the arrival of the data at 520, such as where the uplink grant 524 is a configured grant. (In some such scenarios, no BSR 522 is transmitted in response to the arrival of data 520).

In some embodiments, the communications device 104 determines that low priority data is available for transmission and determines that communications resources have been selected or allocated for the transmission of the low priority data. At (or prior) to both of these conditions having been satisfied, the communications device determines that higher priority data is available for transmission and determines that communications resources have been selected or allocated for the transmission of the high priority data. Accordingly, the communications device is able to determine that the communications resources allocated for the low priority data cannot be used for the transmission of the low priority data, due to the availability of high priority data to be transmitted using the (colliding) resources allocated (or selected) for the transmission of the high priority data.

In such scenarios, in accordance with embodiments of the present technique, the communications device nevertheless stores one or more parameters associated with the grant of the resources for the transmission of the lower priority data. The low priority data is subsequently transmitted in accordance with the one or more parameters.

In the example of FIG. 5, both the determination that the low priority (LCP=6) data is available for transmission and the determination that communications resources have been selected or allocated for the transmission of the low priority data occur at or after time t3. At this time, however, the communications device 104 has already selected communications resources for the transmission of higher priority data, and identified the high priority data to be transmitted. In fact, the communications device was able to form the high priority PDU formed at 518 at any time after time t1.

Thus in the example of FIG. 5, in the communications device 104, the availability of the high priority data to be transmitted is determined before the communications resources for the transmission of the higher priority data are selected. However, in some embodiments, these may occur in a different order.

For example, the high priority data may arrive at the RLC buffers 502 after time t1 and before time t3.

Similarly, in the example of FIG. 5, availability of low priority data is determined before the communications resources are allocated; however in some embodiments, these steps may be in a different order. For example, in some embodiments, the determination of the availability of the low priority data, and the determination that the low priority data cannot be transmitted using the allocated communications resources is after the reception of the grant 524 i.e. after time t3 and before time t4.

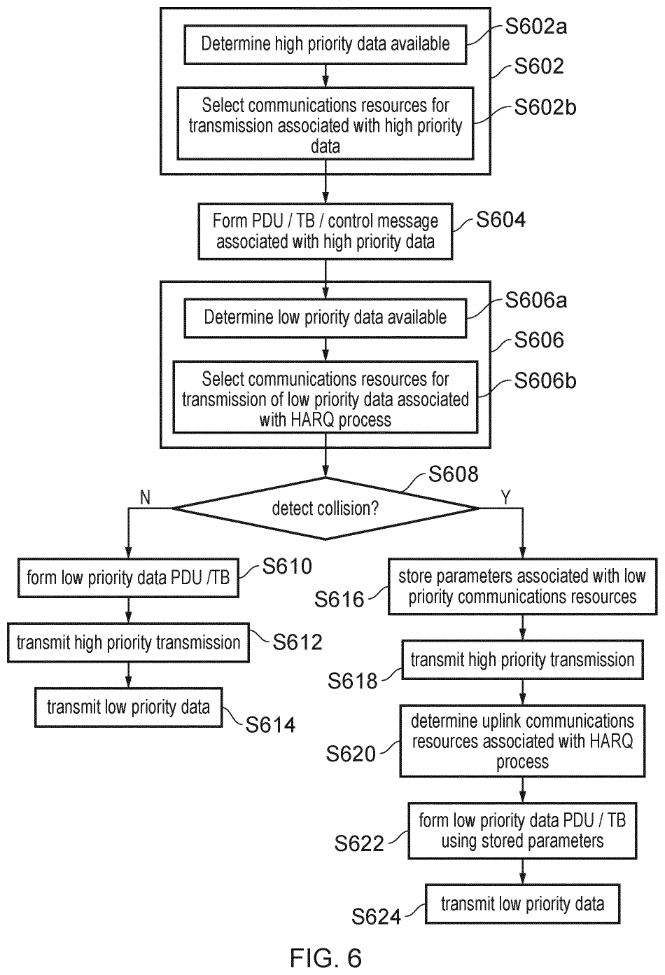

FIG. 6 illustrates a flow chart for a process for a communications device in accordance with embodiments of the present technique.

The process starts with step S602, which comprises step S602a and S602b. At step S602a, the communications device 104 determines that high priority data is available for transmission (or that a transmission, such as an SR, associated with high priority is to be transmitted). For example, the high priority data may be associated with a logical channel having a first logical channel priority.

At step S602b, the communications device 104 determines (e.g. selects and/or receives an allocation of) communications resources for the transmission of the data or control message identified in step S602a.

The process continues with step S604, in which the communications device 104 forms a protocol data unit (PDU), or transport block (TB) comprising the data or control message identified in step S602a for transmission using the resources determined in step S602b.

The process continues with step S606, which comprises step S606a and step S606b. At step S606a, the communications device 104 determines that low priority data is available for transmission. For example, the low priority data may be associated with a logical channel having a second logical channel priority, lower (in priority terms) than the first logical channel priority. It will be appreciated that logical channel priorities may be represented by values, where lower values represent higher priorities, and vice versa.

At step S606b, the communications device 104 determines (e.g. selects and/or receives an allocation of) communications resources for the transmission of the data identified in step S606a. The communications resources may be associated with a HARQ process.

At step S608, the communications device 104 determines whether the communications resources selected or otherwise determined at steps S602b and S606b are compatible. That is, whether the communications device 104 is capable of transmitting using both communications resources.

For example, the communications device 104 may determine that the communications resources are not compatible (i.e., ‘collide’) if they overlap in time. Additionally or alternatively, the communications device 104 may determine that the communications resources are not compatible (i.e., ‘collide’) if they are separated in time by less than a predetermined duration.

The determination at step S608 may depend on the frequency ranges associated with the communications resources. For example, the communications device may determine that the resources are not compatible if they are overlapping in time and span (i.e. the difference in frequency between a lowest frequency used in either resources and a highest frequency used by either resources) a frequency range greater than a predetermined threshold, and/or if the resources are within different frequency bands.

It will be appreciated that other considerations may be taken into account in determining the compatibility of the resources, and that the present disclosure is not limited to those examples provided explicitly herein.

If at step S608 it is determined that the communications resources are compatible (i.e. do not ‘collide’) then control passes to step S610. At step S610, a transport block or PDU is formed from the low priority data identified at step S606a in accordance with parameters associated with the granted communications resources determined at step S606b. For example, the transport block size may be determined based on a coding rate, modulation scheme, and redundancy version indicated by an uplink grant received from the infrastructure equipment.

At step S612 and step S614 the high priority data PDU (or control message) formed at step S604 and the low priority data PDU formed at step S610 are respectively transmitted using the resources identified at steps S602b and S606b, respectively.

The process may continue in accordance with conventional techniques, the details of which are omitted for conciseness.

If at step S608 it is determined that the communications resources are not compatible, the control passes to step S616. At step S616, one or more parameters associated with the communications resources determined at step S606b are stored. The one or more parameters may comprise parameters indicated by the uplink grant allocating these communications resources, such as modulation scheme, coding rate, and the like.

These parameters are stored even though the uplink communications resources identified at step S606b will not be used for the transmission of low priority data.

Subsequently, at step S618 the high priority data PDU (or control message) formed at step S604 is transmitted using the resources identified at step S602b.

Control then passes to step S620.

At step S620, uplink communications resources for a (re-)transmission of low priority data are determined by the communications device 104. This may be based on an indication of communications resources in an uplink grant transmitted by the infrastructure equipment 101 to the communications device 104. The uplink grant may comprise an indication of the HARQ process associated with the communications resources determined in step S606b. The uplink grant may comprise an implicit indication that data previously associated with the HARQ process is to be retransmitted e.g. in the form of an NDI having a same value as a previous NDI value associated with the same HARQ process. In some embodiments, the uplink grant received at step S620 omits one or more parameters required for forming a PDU or transport block for transmission using the allocated communications resources.

Subsequently, at step S622, the communications device 104 retrieves the one or more parameters stored at step S616 and, based on these and the uplink communications resources determined at step S620, generates a PDU and forms a transport block, and encodes it for transmission. At step S624 the communications device transmits it using the communications resources determined at step S620.

In some embodiments, the storage of parameters at step S616 may consist of or comprise storing one or more parameters which are calculated based on the parameters indicated in the uplink grant of the communications resources selected in step S606b. For example, at step S616, the communications device 104 may calculate a transport block size. The calculation may be based on indications of a modulation scheme and a coding rate in an uplink grant. At step S622, the communications device 104 may retrieve the stored parameter (such as the calculated transport block size), and form the new low priority data block in accordance with the stored parameter.

In some embodiments, in response to receiving an uplink grant with NDI indicating that data previously transmitted is to be discarded, the communications device determines whether buffered data has in fact been previously transmitted. If the buffered data has not been previously transmitted, then the buffered data is transmitted using the allocated communications resources. In some embodiments, a transport block comprising the buffered data is newly encoded in accordance with one or more parameters received in the uplink grant. In some embodiments, the buffered data is transmitted in accordance with one or more parameters indicated in an earlier uplink grant indication associated with the same HARQ process.

In some embodiments, the buffered data is transmitted using the allocated communications resources if the communications device determines that the buffered data has not been previously transmitted because previously selected communications resources for the transmission of data in accordance with the HARQ process were not used for the transmission of that data as a result of a collision between those communications resources and other communications resources selected for a transmission associated with data having a higher priority.

Accordingly, the communications device may refrain from discarding a PDU formed and buffered for transmission using the previously allocated communications resources. The communications device may then transmit data (e.g. the buffered PDU) which would, absent the collision, have been transmitted using the previously allocated communications resources.

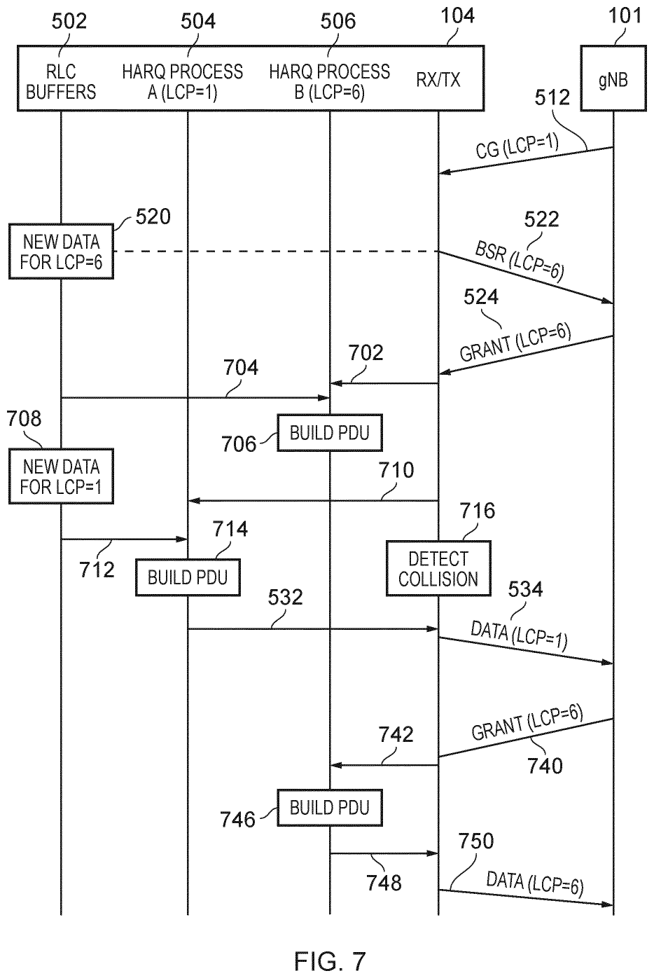

FIG. 7 illustrates a combined message sequence chart and process flow chart and associated transmissions in accordance with embodiments of the present technique.

Many of the elements of FIG. 7 correspond to those illustrated in FIG. 5 and described above, and these are denoted by reference numerals which have been used and described in respect of FIG. 5.

Accordingly, only different aspects will be described here for conciseness.

Unlike the example of FIG. 5, in the example of FIG. 7 there is initially no high priority (LCP=1) data available.

In the example of FIG. 7, both the determination of uplink communications resources for the transmission of the lower priority data, and the availability of the lower priority data occur prior to the formation of a PDU of higher priority data. The formation of the higher priority data PDU is dependent on both the availability of the higher priority data and the determination of the communications resources for the transmission of the higher priority data.

Accordingly, in FIG. 7, in response to receiving the uplink grant 524 which is associated with the HARQ process B 506 (as indicated at 702), the communications device retrieves at 704 low priority data from the RLC buffers 502. At 706, the low priority PDU and corresponding transport block is formed, based on the parameters indicated in the uplink grant 524.

Subsequently, at 708, new data arrives with LCP=1. HARQ process A 504 then retrieves 710 parameters associated with the CG 512 (if HARQ process A 504 does not already have those stored) and retrieves 712 data with LCP=1 from the RLC buffers 502. The HARQ process A 504 then forms, at 714, a high priority data PDU and transport block.

At 716, the communications device 104 determines that resources allocated by the configured grant 512 and by the uplink grant 524 collide such that the communications device is unable to transmit using both allocated resources. Moreover, the communications device 104 determines that the PDU formed at 706 cannot be transmitted using the resources allocated by the uplink grant 524, because a higher priority PDU is available for transmission.

Accordingly, at 532, the high priority PDU is transferred from the HARQ process A 504 and transmitted at 534.

Subsequently, the infrastructure equipment 101 transmits a further uplink grant 740, indicating the HARQ process B 506. In the example of FIG. 7, the further uplink grant 740 comprises an NDI which indicates that the indicated HARQ buffer is to be flushed, i.e. that any data associated with the indicated HARQ process is to be discarded and not to be transmitted using the allocated communications resources.

In accordance with some embodiments of the present technique, the communications device 104 determines that in fact the data buffered and associated with the HARQ process B 506 has not yet been transmitted, and accordingly refrains from discarding the data.

In accordance with some embodiments of the present technique, the communications device 104 forms 746 a PDU and transport block for transmission, based on the same data that was used to form the PDU at 706. That is, the communications device 104 determines that the data to be transmitted using the resources allocated by the further uplink grant 740 is to be the same as that which would have been transmitted using the resources allocated by the uplink grant 524, were there no collision (and/or no high priority PDU to be transmitted).

The formation of the PDU at 746 may be in some embodiments in accordance with parameters indicated in the further uplink grant 740. In some embodiments, formation of the PDU at 746 may be in accordance with parameters indicated in the uplink grant 524.

The PDU formed at 746 is transferred 748 and transmitted 750 using the communications resources allocated by the further uplink grant 740.

Thus in some embodiments, the communications device 104 transmits a PDU in accordance with a HARQ process, in response to an uplink grant, irrespective of the presence in the grant of an indication that data currently associated with (e.g. buffered by) that HARQ process is to be discarded and not to form the basis of a further transmission. This transmission may be in response to a determination that the data currently associated with (e.g. buffered by) that HARQ process has not been previously transmitted, as a result of a collision between communications resources allocated for the transmission of that data and communications resources allocated for a transmission associated with higher priority data.

Embodiments of the present technique therefore ensure that data which has been buffered and/or formed into a PDU in response to an uplink grant, but then not transmitted using the communications resources allocated by the uplink grant, is transmitted and not discarded, irrespective of an NDI in a subsequent uplink grant which indicates (implicitly) that a buffered PDU may be discarded.

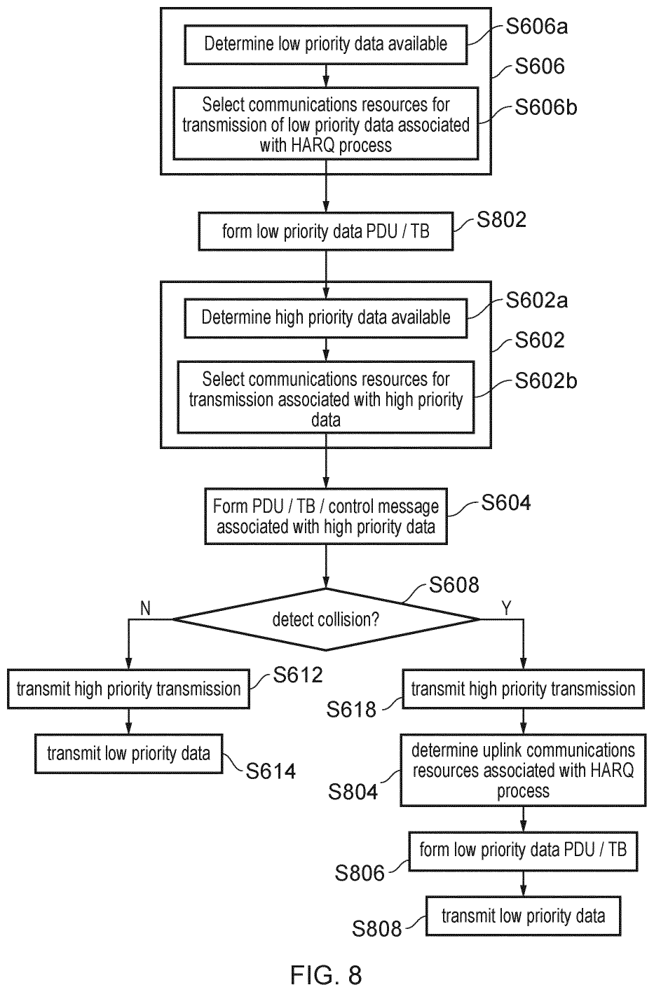

FIG. 8 illustrates a flow chart for a process for a communications device in accordance with embodiments of the present technique.

Many of the steps of the process of FIG. 8 correspond to those in the process of FIG. 6 and are labelled with corresponding reference numerals. Their description will be omitted here for conciseness.

The process of FIG. 8 differs from that of the process of FIG. 6 in that the order of completion of steps S606 and S602 is reversed: high priority data and communications resources selected for its transmission are not available until after the communications device is able to form a PDU comprising low priority data. Accordingly, step S802, in which a low priority data PDU and/or TB is formed, occurs after step S606.

As in the process of FIG. 6, if no collision is detected at step S608, then the data/transmissions are transmitted using their respective communications resources at steps S612 and S614.

Similarly, as in the process of FIG. 6, if a collision is detected at step S608, then the transmission associated with the high priority data is transmitted using the corresponding communications resources at step S618.

Step S804 is substantially the same as step S620. However, in the example of FIG. 8 (not shown), the determined communications resources are associated with an NDI which may indicate that data currently associated with (e.g. buffered by) the associated HARQ process is to be discarded and not further transmitted.

In accordance with embodiments of the present technique, however, at step S806, the communications device determines that the data associated with the HARQ process was previously prevented from being transmitted as a result of the collision detected at step S608. Accordingly, the low priority PDU/TB is formed at step S622 without regards to the NDI associated with the uplink resources determined at step S804. In particular, even if the NDI associated with the uplink resources indicates that data previously associated with the HARQ process is to be discarded (e.g. by being flushed from the corresponding HARQ buffer) and not to be used for forming a PDU or TB to be transmitted using the allocated uplink resources, the communications device nevertheless prepares for transmission a PDU and TB based on the low priority data identified at step S606a.

In some embodiments, the PDU formed at step S806 is the same as that formed at step S802. This may be, for example, because the parameters for encoding the PDU and TB indicated (implicitly or explicitly) by the grant used to determine the uplink resources at step S804 (such as the grant 740 of FIG. 7) are the same as those indicated by an earlier grant used at step S606b (such as the grant 524 of FIG. 7).

In some embodiments, the PDU/TB formed at step S806 is formed in accordance with parameters indicated in a grant of the uplink resources determined at step S804.

Subsequently at step S808, the low priority data, as formed into a PDU/TB at step S806 is transmitted using the communications resources identified at step S804.

It will be appreciated that the processes and sequences illustrated in FIG. 5, FIG. 6, FIG. 7 and FIG. 8 may be modified and that one or more steps may be omitted, modified or re-ordered. For example, in FIG. 6, steps S602a and S602b may occur in a different order. Indeed, in general, steps

S602a, S602b, S606a and S606b may occur in any order such that step S602 is completed prior to step S606. Similarly in FIG. 8, steps S602a, S602b, S606a and S606b may occur in any order such that step S606 is completed prior to step S602.

In some embodiments, aspects of the processes illustrated in FIG. 5, FIG. 6, FIG. 7 and FIG. 8 may be combined. For example, in some embodiments, parameters indicated as being associated with communications resources initially selected for the transmission of low priority data may be used to encode data transmitted subsequently using further communications resources, and irrespective of an NDI associated with the further communications resources.

In some embodiments, the communications resources selected for the transmission of the high priority data may be determined based on a configured grant. In some embodiments, the communications resources selected for the transmission of the high priority data may be determined based on a dynamic grant.

Thus there has been described a method of transmitting data by a communications device in a wireless communications network, the method comprising determining that first data having a first priority is available for transmission by the communications device, selecting first uplink communications resources for a transmission associated with the first data, determining second uplink communications resources allocated for transmitting second data associated with a second priority and one or more parameters for the transmission of the second data using the second uplink communications resources, the second priority being lower than the first priority, after the determining that the first data is available for transmission and the selecting the first uplink communications resources, determining based on the first uplink communications resources that the second uplink communications resources cannot be used for the transmission of the second data, storing the one or more parameters, transmitting the transmission associated with the first data using the first uplink communications resources and refraining from transmitting the second data using the second uplink communications resources, receiving an uplink grant, the uplink grant comprising an indication of third uplink communications resources allocated for transmitting the data having the second priority, and transmitting the second data using the third uplink communications resources in accordance with the stored one or more parameters.

There has further been described method of transmitting data by a communications device in a wireless communications network, the method comprising determining that first data having a first priority is available for transmission by the communications device, selecting first uplink communications resources for a transmission associated with the first data, determining second uplink communications resources allocated for transmitting second data associated with a second priority and an indication of one or more parameters for the transmission of the second data using the second uplink communications resources, the second priority being lower than the first priority, the second uplink communications resources associated with an acknowledgement process, associating the second data with the acknowledgement process, determining based on the first uplink communications resources that the second uplink communications resources cannot be used for the transmission of the second data, transmitting the transmission associated with the first data using the first uplink communications resources and refraining from transmitting the second data using the second uplink communications resources, receiving an uplink grant, the uplink grant comprising an indication of third uplink communications resources associated with the acknowledgement process and comprising a new data indicator that indicates whether data previously associated with the acknowledgement process is not to form the basis of a transmission using the third uplink communications resources, and in response to determining, based on the first uplink communications resources, that the second uplink communications resources cannot be used for the transmission of the second data, transmitting the second data using the third uplink communications resources irrespective of the new data indicator.

There has further been described a method of receiving data by an infrastructure equipment in a wireless communications network, the method comprising selecting second uplink communications resources and one or more parameters for a transmission of second data having a second priority by a communications device, transmitting an uplink grant to the communications device, the uplink grant comprising an indication of the second uplink communications resources and the one or more parameters, receiving a transmission associated with first data, the first data having a first priority higher than the second priority and transmitted using first uplink communications resources, determining that signals received using the second uplink communications resources could not be decoded correctly to decode the second data, in response to determining that the signals received using the second uplink communications resources could not be decoded correctly, transmitting a second uplink grant, the second uplink grant comprising an indication of third uplink communications resources allocated for transmitting the data having the second priority, and receiving the data having the second priority using the third uplink communications resources in accordance with the one or more parameters, wherein the communications device is not capable of transmitting using both the first uplink communications resources and the second uplink communications resources.

Corresponding communications devices, infrastructure equipment and methods therefore, and circuitry for a communications device and circuitry for an infrastructure equipment have also been described.

It will be appreciated that while the present disclosure has in some respects focused on implementations in an LTE-based and/or 5G network for the sake of providing specific examples, the same principles can be applied to other wireless telecommunications systems. Thus, even though the terminology used herein is generally the same or similar to that of the LTE and 5G standards, the teachings are not limited to the present versions of LTE and 5G and could apply equally to any appropriate arrangement not based on LTE or 5G and/or compliant with any other future version of an LTE, 5G or other standard.

It may be noted various example approaches discussed herein may rely on information which is predetermined/predefined in the sense of being known by both the infrastructure equipment and the communications device. It will be appreciated such predetermined/predefined information may in general be established, for example, by definition in an operating standard for the wireless telecommunication system, or in previously exchanged signalling between the infrastructure equipment and communications devices, for example in system information signalling, or in association with radio resource control setup signalling, or in information stored in a SIM application. That is to say, the specific manner in which the relevant predefined information is established and shared between the various elements of the wireless telecommunications system is not of primary significance to the principles of operation described herein. It may further be noted various example approaches discussed herein rely on information which is exchanged/communicated between various elements of the wireless telecommunications system and it will be appreciated such communications may in general be made in accordance with conventional techniques, for example in terms of specific signalling protocols and the type of communication channel used, unless the context demands otherwise. That is to say, the specific manner in which the relevant information is exchanged between the various elements of the wireless telecommunications system is not of primary significance to the principles of operation described herein.

It will be appreciated that the principles described herein are not applicable only to certain types of communications device, but can be applied more generally in respect of any types of communications device, for example the approaches are not limited to URLLC/IIoT devices or other low latency communications devices, but can be applied more generally, for example in respect of any type of communications device operating with a wireless link to the communication network.

It will further be appreciated that the principles described herein are applicable not only to LTE-based or 5G/NR-based wireless telecommunications systems, but are applicable for any type of wireless telecommunications system that supports a dynamic scheduling of shared communications resources.

Further particular and preferred aspects of the present invention are set out in the accompanying independent and dependent claims. It will be appreciated that features of the dependent claims may be combined with features of the independent claims in combinations other than those explicitly set out in the claims.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

Respective features of the present disclosure are defined by the following numbered paragraphs:

Paragraph 1. A method of transmitting data by a communications device in a wireless communications network, the method comprising determining that first data having a first priority is available for transmission by the communications device, selecting first uplink communications resources for a transmission associated with the first data, determining second uplink communications resources allocated for transmitting second data associated with a second priority and one or more parameters for the transmission of the second data using the second uplink communications resources, the second priority being lower than the first priority, after the determining that the first data is available for transmission and the selecting the first uplink communications resources, determining based on the first uplink communications resources that the second uplink communications resources cannot be used for the transmission of the second data, storing the one or more parameters, transmitting the transmission associated with the first data using the first uplink communications resources and refraining from transmitting the second data using the second uplink communications resources, receiving an uplink grant, the uplink grant comprising an indication of third uplink communications resources allocated for transmitting the data having the second priority, and transmitting the second data using the third uplink communications resources in accordance with the stored one or more parameters.

Paragraph 2. A method according to paragraph 1, wherein the determining that the second uplink communications resources cannot be used for the transmission of the second data is in response to the receiving the uplink grant comprising the indication of the second uplink communications resources.

Paragraph 3. A method according to paragraph 1 or paragraph 2, wherein the determining that the second uplink communications resources cannot be used for the transmission of the second data is in response to determining that the second data is available for transmission by the communications device.

Paragraph 4. A method according to any of paragraphs 1 to 3, wherein the transmission associated with the first data comprises a scheduling request message requesting an allocation of uplink communications resources for the transmission of a protocol data unit comprising the first data.

Paragraph 5. A method according to paragraph 4, wherein the first uplink communications resources comprise resources of an uplink control channel.

Paragraph 6. A method according to any of paragraphs 1 to 3, wherein the transmission associated with the first data comprises a transmission of a protocol data unit comprising the first data.

Paragraph 7. A method according to paragraph 6, the method comprising: in response to determining that first data is available for transmission by the communications device, transmitting a request for an allocation of uplink communications resources for transmitting the first data, wherein selecting the first uplink communications resources comprises receiving an uplink grant indicating the first uplink communications resources, the uplink grant transmitted in response to the request for the allocation of the uplink communications resources for transmitting the first data.

Paragraph 8. A method according to paragraph 6, the method comprising receiving an indication of one or more of instances of communications resources for the transmission of data having the first priority, wherein selecting the first uplink communications resources comprises selecting one of the plurality of instances of communications resources.

Paragraph 9. A method according to paragraph 8, wherein the indication of the one or more instances of communications resources is received in a radio resource control (RRC) message.

Paragraph 10. A method according to any of paragraphs 3 to 9, the method comprising: in response to determining that the second data is available for transmission by the communications device, transmitting a request for an allocation of uplink communications resources for transmitting the second data, wherein selecting the second uplink communications resources comprises receiving a further uplink grant indicating the second uplink communications resources, the further uplink grant transmitted in response to the request for the allocation of the uplink communications resources for transmitting the second data.

Paragraph 11. A method according to paragraph 10, the method comprising receiving an indication of a plurality of instances of communications resources for the transmission of data having the second priority, wherein selecting the second uplink communications resources comprises selecting one of the plurality of instances of communications resources.

Paragraph 12. A method according to any of paragraphs 1 to 11, wherein the one or more parameters for the transmission of the second data are for determining an amount of data having the second priority that is to be transmitted using the second uplink communications resources and transmitting the second data using the third uplink communications resources in accordance with the stored one or more parameters for the transmissions of the second data comprises transmitting the amount of data having the second priority.

Paragraph 13. A method according to any of paragraphs 1 to 12, wherein the one or more parameters for the transmission of the second data comprise one or more of a modulation scheme, a coding rate, a new data indicator, a hybrid automatic repeat request (HARQ) process number and a redundancy version.

Paragraph 14. A method according to any of paragraphs 3 to 13, wherein the uplink grant comprises an indicator that the third uplink communications resources are to be used for a first transmission of data having the second priority.

Paragraph 15. A method according to any of paragraphs 3 to 14, wherein the second uplink communications resources are associated with an acknowledgement process, the uplink grant is associated with the acknowledgement process and comprises a new data indicator that indicates whether data associated with the acknowledgement process may form the basis of a transmission using the third uplink communications resources, the method comprising, in response to determining that the second data is available for transmission by the communications device, associating the second data with the acknowledgement process, in response to the determining, based on the first uplink communications resources, that the second uplink communications resources cannot be used for the transmission of the second data, transmitting the second data using the third uplink communications resources irrespective of the new data indicator.

Paragraph 16. A method according to paragraph 15, wherein the new data indicator indicates that data associated with the acknowledgement process is not to form the basis of a transmission using the third uplink communications resources.

Paragraph 17. A method according to paragraph 15 or paragraph 16, the method comprising refraining from flushing data stored in a buffer associated with the acknowledgement process.

Paragraph 18. A method according to any of paragraphs 15 to 17, the method comprising forming a protocol data unit comprising the second data.

Paragraph 19. A method according to Paragraph 18 wherein the protocol data unit comprises data from a radio link control (RLC) layer that has not previously been transmitted.

Paragraph 20. A method of transmitting data by a communications device in a wireless communications network, the method comprising determining that first data having a first priority is available for transmission by the communications device, selecting first uplink communications resources for a transmission associated with the first data, determining second uplink communications resources allocated for transmitting second data associated with a second priority and an indication of one or more parameters for the transmission of the second data using the second uplink communications resources, the second priority being lower than the first priority, the second uplink communications resources associated with an acknowledgement process, associating the second data with the acknowledgement process, determining based on the first uplink communications resources that the second uplink communications resources cannot be used for the transmission of the second data, transmitting the transmission associated with the first data using the first uplink communications resources and refraining from transmitting the second data using the second uplink communications resources, receiving an uplink grant, the uplink grant comprising an indication of third uplink communications resources associated with the acknowledgement process and comprising a new data indicator that indicates whether data previously associated with the acknowledgement process is not to form the basis of a transmission using the third uplink communications resources, and in response to determining, based on the first uplink communications resources, that the second uplink communications resources cannot be used for the transmission of the second data, transmitting the second data using the third uplink communications resources irrespective of the new data indicator.

Paragraph 21. A method according to paragraph 20, wherein the new data indicator indicates that data associated with the acknowledgement process is not to form the basis of a transmission using the third uplink communications resources.

Paragraph 22. A method according to paragraph 20 or paragraph 21, the method comprising refraining from flushing data stored in a buffer associated with the acknowledgement process.

Paragraph 23. A method according to any of paragraphs 20 to 22, the method comprising forming a protocol data unit comprising the second data.

Paragraph 24. A method according to Paragraph 23 wherein the protocol data unit comprises data from a radio link control (RLC) layer that has not previously been transmitted.

Paragraph 25. A method of receiving data by an infrastructure equipment in a wireless communications network, the method comprising selecting second uplink communications resources and one or more parameters for a transmission of second data having a second priority by a communications device, transmitting an uplink grant to the communications device, the uplink grant comprising an indication of the second uplink communications resources and the one or more parameters, receiving a transmission associated with first data, the first data having a first priority higher than the second priority and transmitted using first uplink communications resources, determining that signals received using the second uplink communications resources could not be decoded correctly to decode the second data, in response to determining that the signals received using the second uplink communications resources could not be decoded correctly, transmitting a second uplink grant, the second uplink grant comprising an indication of third uplink communications resources allocated for transmitting the data having the second priority, and receiving the data having the second priority using the third uplink communications resources in accordance with the one or more parameters, wherein the communications device is not capable of transmitting using both the first uplink communications resources and the second uplink communications resources.

26. A communications device for operating in a wireless communications network, the communications device comprising a transmitter configured to transmit signals via a wireless access interface provided by an infrastructure equipment of the wireless communications network, a receiver configured to receive signals via the wireless access interface, and a controller configured to control the transmitter and the receiver so that the communications device is operable: to determine that first data having a first priority is available for transmission by the communications device, to select first uplink communications resources for a transmission associated with the first data, to determine second uplink communications resources allocated for transmitting second data associated with a second priority and one or more parameters for the transmission of the second data using the second uplink communications resources, the second priority being lower than the first priority, after the determining that the first data is available for transmission and the selecting the first uplink communications resources, to determine based on the first uplink communications resources that the second uplink communications resources cannot be used for the transmission of the second data, to store the one or more parameters, to transmit the transmission associated with the first data using the first uplink communications resources and to refrain from transmitting the second data using the second uplink communications resources, to receive an uplink grant, the uplink grant comprising an indication of third uplink communications resources allocated for transmitting the data having the second priority, and to transmit the second data using the third uplink communications resources in accordance with the stored one or more parameters.

Paragraph 27. Circuitry for a communications device for operating in a wireless communications network, the circuitry comprising transmitter circuitry configured to transmit signals via a wireless access interface provided by an infrastructure equipment of the wireless communications network, receiver circuitry configured to receive signals via the wireless access interface, and controller circuitry configured to control the transmitter and the receiver so that the communications device is operable: to determine that first data having a first priority is available for transmission by the communications device, to select first uplink communications resources for a transmission associated with the first data, to determine second uplink communications resources allocated for transmitting second data associated with a second priority and one or more parameters for the transmission of the second data using the second uplink communications resources, the second priority being lower than the first priority, after the determining that the first data is available for transmission and the selecting the first uplink communications resources, to determine based on the first uplink communications resources that the second uplink communications resources cannot be used for the transmission of the second data, to store the one or more parameters, to transmit the transmission associated with the first data using the first uplink communications resources and to refrain from transmitting the second data using the second uplink communications resources, to receive an uplink grant, the uplink grant comprising an indication of third uplink communications resources allocated for transmitting the data having the second priority, and to transmit the second data using the third uplink communications resources in accordance with the stored one or more parameters.

Paragraph 28. A communications device for operating in a wireless communications network, the communications device comprising a transmitter configured to transmit signals via a wireless access interface provided by an infrastructure equipment of the wireless communications network, a receiver configured to receive signals via the wireless access interface, and a controller configured to control the transmitter and the receiver so that the communications device is operable: to determine that first data having a first priority is available for transmission by the communications device, to select first uplink communications resources for a transmission associated with the first data, to determine second uplink communications resources allocated for transmitting second data associated with a second priority and one or more parameters for the transmission of the second data using the second uplink communications resources, the second priority being lower than the first priority, the second uplink communications resources associated with an acknowledgement process, to associate the second data with the acknowledgement process, to determine based on the first uplink communications resources that the second uplink communications resources cannot be used for the transmission of the second data, to transmit the transmission associated with the first data using the first uplink communications resources and refraining from transmitting the second data using the second uplink communications resources, to receive an uplink grant, the uplink grant comprising an indication of third uplink communications resources associated with the acknowledgement process and comprising a new data indicator that indicates whether data previously associated with the acknowledgement process is not to form the basis of a transmission using the third uplink communications resources, and in response to determining, based on the first uplink communications resources, that the second uplink communications resources cannot be used for the transmission of the second data, to transmit the second data using the third uplink communications resources irrespective of the new data indicator.

Paragraph 29. Circuitry for a communications device for operating in a wireless communications network, the circuitry comprising transmitter circuitry configured to transmit signals via a wireless access interface provided by an infrastructure equipment of the wireless communications network, receiver circuitry configured to receive signals via the wireless access interface, and controller circuitry configured to control the transmitter circuitry and the receiver circuitry so that the communications device is operable: to determine that first data having a first priority is available for transmission by the communications device, to select first uplink communications resources for a transmission associated with the first data, to determine second uplink communications resources allocated for transmitting second data associated with a second priority and one or more parameters for the transmission of the second data using the second uplink communications resources, the second priority being lower than the first priority, the second uplink communications resources associated with an acknowledgement process, to associate the second data with the acknowledgement process, to determine based on the first uplink communications resources that the second uplink communications resources cannot be used for the transmission of the second data, to transmit the transmission associated with the first data using the first uplink communications resources and refraining from transmitting the second data using the second uplink communications resources, to receive an uplink grant, the uplink grant comprising an indication of third uplink communications resources associated with the acknowledgement process and comprising a new data indicator that indicates whether data previously associated with the acknowledgement process is not to form the basis of a transmission using the third uplink communications resources, and in response to determining, based on the first uplink communications resources, that the second uplink communications resources cannot be used for the transmission of the second data, to transmit the second data using the third uplink communications resources irrespective of the new data indicator.

Paragraph 30. Infrastructure equipment for use in a wireless communications network, the infrastructure equipment providing a wireless access interface for communicating with a communications device, the infrastructure equipment comprising a transmitter configured to transmit signals to the communications device via the wireless access interface, a receiver configured to receive signals from the communications device, and a controller configured to control the transmitter and the receiver so that the infrastructure equipment is operable: to select second uplink communications resources and one or more parameters for a transmission of second data having a second priority by a communications device, to transmit an uplink grant to the communications device, the uplink grant comprising an indication of the second uplink communications resources and the one or more parameters, to receive a transmission associated with first data, the first data having a first priority higher than the second priority and transmitted using first uplink communications resources, to determine that signals received using the second uplink communications resources could not be decoded correctly to decode the second data, in response to determining that the signals received using the second uplink communications resources could not be decoded correctly, to transmit a second uplink grant, the second uplink grant comprising an indication of third uplink communications resources allocated for transmitting the data having the second priority, and to receive the data having the second priority using the third uplink communications resources in accordance with the one or more parameters, wherein the communications device is not capable of transmitting using both the first uplink communications resources and the second uplink communications resources.

Paragraph 31. Circuitry for infrastructure equipment for use in a wireless communications network, the infrastructure equipment providing a wireless access interface for communicating with a communications device, the circuitry comprising transmitter circuitry configured to transmit signals to the communications device via the wireless access interface, receiver circuitry configured to receive signals from the communications device, and controller circuitry configured to control the transmitter circuitry and the receiver circuitry so that the infrastructure equipment is operable: to select second uplink communications resources and one or more parameters for a transmission of second data having a second priority by a communications device, to transmit an uplink grant to the communications device, the uplink grant comprising an indication of the second uplink communications resources and the one or more parameters, to receive a transmission associated with first data, the first data having a first priority higher than the second priority and transmitted using first uplink communications resources, to determine that signals received using the second uplink communications resources could not be decoded correctly to decode the second data, in response to determining that the signals received using the second uplink communications resources could not be decoded correctly, to transmit a second uplink grant, the second uplink grant comprising an indication of third uplink communications resources allocated for transmitting the data having the second priority, and to receive the data having the second priority using the third uplink communications resources in accordance with the one or more parameters, wherein the communications device is not capable of transmitting using both the first uplink communications resources and the second uplink communications resources.

### REFERENCES

[1] RP-182090, “Revised SID: Study on NR Industrial Internet of Things (IoT),” 3GPP RAN#81.
[2] Holma H. and Toskala A, “LTE for UMTS OFDMA and SC-FDMA based radio access”, John Wiley and Sons, 2009
[3] 3GPP TS 38.321, “Medium Access Control (MAC) protocol specification (Rel-15)”, v15.3.0
[4] 3GPP TS 38.300 V15.4.0
[5] 3GPP TS 38.321 “NR; Medium Access Control (MAC) protocol specification”, version 15.6.0
[6] 3GPP Tdoc R1-1907323 “Procedure for cross-slot scheduling technique”, Ericsson
[7] 3GPP document R2-1818991, “LS on multiple active configured grant configurations”, RAN2#104
[8] 3GPP document RP-182089, “New SID on Physical Layer Enhancements for NR Ultra-Reliable and Low Latency Communication (URLLC),” RAN#81.
[9] 3GPP TR 38.825, “Study on NR Industrial Internet of Things (IoT)”, 3GPP Rel-16.
[10] 3GPP document RP-190728, “New WID: Support of NR Industrial Internet of Things (IoT)”, RAN#83

1. A method of transmitting data by a communications device in a wireless communications network, the method comprising
determining that first data having a first priority is available for transmission by the communications device,
selecting first uplink communications resources for a transmission associated with the first data,
determining second uplink communications resources allocated for transmitting second data associated with a second priority and one or more parameters for the transmission of the second data using the second uplink communications resources, the second priority being lower than the first priority,
after the determining that the first data is available for transmission and the selecting the first uplink communications resources, determining based on the first uplink communications resources that the second uplink communications resources cannot be used for the transmission of the second data,
storing the one or more parameters,
transmitting the transmission associated with the first data using the first uplink communications resources and refraining from transmitting the second data using the second uplink communications resources,
receiving an uplink grant, the uplink grant comprising an indication of third uplink communications resources allocated for transmitting the data having the second priority, and
transmitting the second data using the third uplink communications resources in accordance with the stored one or more parameters.

2. A method according to claim 1, wherein the determining that the second uplink communications resources cannot be used for the transmission of the second data is in response to the receiving the uplink grant comprising the indication of the second uplink communications resources.

3. A method according to claim 1, wherein the determining that the second uplink communications resources cannot be used for the transmission of the second data is in response to determining that the second data is available for transmission by the communications device.

4. A method according to claim 1, wherein the transmission associated with the first data comprises a scheduling request message requesting an allocation of uplink communications resources for the transmission of a protocol data unit comprising the first data.

5. A method according to claim 4, wherein the first uplink communications resources comprise resources of an uplink control channel.

6. A method according to claim 1, wherein the transmission associated with the first data comprises a transmission of a protocol data unit comprising the first data.

7. A method according to claim 6, the method comprising:
in response to determining that first data is available for transmission by the communications device, transmitting a request for an allocation of uplink communications resources for transmitting the first data, wherein
selecting the first uplink communications resources comprises receiving an uplink grant indicating the first uplink communications resources, the uplink grant transmitted in response to the request for the allocation of the uplink communications resources for transmitting the first data.

8. A method according to claim 6, the method comprising
receiving an indication of one or more of instances of communications resources for the transmission of data having the first priority, wherein
selecting the first uplink communications resources comprises selecting one of the plurality of instances of communications resources.

9. A method according to claim 8, wherein the indication of the one or more instances of communications resources is received in a radio resource control (RRC) message.

10. A method according to claim 3, the method comprising:
in response to determining that the second data is available for transmission by the communications device, transmitting a request for an allocation of uplink communications resources for transmitting the second data, wherein
selecting the second uplink communications resources comprises receiving a further uplink grant indicating the second uplink communications resources, the further uplink grant transmitted in response to the request for the allocation of the uplink communications resources for transmitting the second data.

11. A method according to claim 10, the method comprising
receiving an indication of a plurality of instances of communications resources for the transmission of data having the second priority, wherein
selecting the second uplink communications resources comprises selecting one of the plurality of instances of communications resources.

12. A method according to claim 1, wherein the one or more parameters for the transmission of the second data are for determining an amount of data having the second priority that is to be transmitted using the second uplink communications resources and
transmitting the second data using the third uplink communications resources in accordance with the stored one or more parameters for the transmissions of the second data comprises transmitting the amount of data having the second priority.

13. A method according to claim 1, wherein the one or more parameters for the transmission of the second data comprise one or more of a modulation scheme, a coding rate, a new data indicator, a hybrid automatic repeat request (HARQ) process number and a redundancy version.

14. A method according to claim 3, wherein the uplink grant comprises an indicator that the third uplink communications resources are to be used for a first transmission of data having the second priority.

15. A method according to claim 3, wherein
the second uplink communications resources are associated with an acknowledgement process,
the uplink grant is associated with the acknowledgement process and comprises a new data indicator that indicates whether data associated with the acknowledgement process may form the basis of a transmission using the third uplink communications resources, the method comprising,
in response to determining that the second data is available for transmission by the communications device, associating the second data with the acknowledgement process,
in response to the determining, based on the first uplink communications resources, that the second uplink communications resources cannot be used for the transmission of the second data, transmitting the second data using the third uplink communications resources irrespective of the new data indicator.

16. A method according to claim 15, wherein
the new data indicator indicates that data associated with the acknowledgement process is not to form the basis of a transmission using the third uplink communications resources.

17. A method according to claim 15, the method comprising refraining from flushing data stored in a buffer associated with the acknowledgement process.

18. A method according to claim 15, the method comprising forming a protocol data unit comprising the second data.

19.-26. (canceled)

27. Circuitry for a communications device for operating in a wireless communications network, the circuitry comprising
transmitter circuitry configured to transmit signals via a wireless access interface provided by an infrastructure equipment of the wireless communications network,
receiver circuitry configured to receive signals via the wireless access interface, and
controller circuitry configured to control the transmitter and the receiver so that the communications device is operable:
to determine that first data having a first priority is available for transmission by the communications device,
to select first uplink communications resources for a transmission associated with the first data,
to determine second uplink communications resources allocated for transmitting second data associated with a second priority and one or more parameters for the transmission of the second data using the second uplink communications resources, the second priority being lower than the first priority,
after the determining that the first data is available for transmission and the selecting the first uplink communications resources, to determine based on the first uplink communications resources that the second uplink communications resources cannot be used for the transmission of the second data,
to store the one or more parameters,
to transmit the transmission associated with the first data using the first uplink communications resources and to refrain from transmitting the second data using the second uplink communications resources,
to receive an uplink grant, the uplink grant comprising an indication of third uplink communications resources allocated for transmitting the data having the second priority, and
to transmit the second data using the third uplink communications resources in accordance with the stored one or more parameters.

28. (canceled)

29. Circuitry for a communications device for operating in a wireless communications network, the circuitry comprising
transmitter circuitry configured to transmit signals via a wireless access interface provided by an infrastructure equipment of the wireless communications network,
receiver circuitry configured to receive signals via the wireless access interface, and
controller circuitry configured to control the transmitter circuitry and the receiver circuitry so that the communications device is operable:
to determine that first data having a first priority is available for transmission by the communications device,
to select first uplink communications resources for a transmission associated with the first data,
to determine second uplink communications resources allocated for transmitting second data associated with a second priority and one or more parameters for the transmission of the second data using the second uplink communications resources, the second priority being lower than the first priority, the second uplink communications resources associated with an acknowledgement process,
to associate the second data with the acknowledgement process,
to determine based on the first uplink communications resources that the second uplink communications resources cannot be used for the transmission of the second data,
to transmit the transmission associated with the first data using the first uplink communications resources and refraining from transmitting the second data using the second uplink communications resources,
to receive an uplink grant, the uplink grant comprising an indication of third uplink communications resources associated with the acknowledgement process and comprising a new data indicator that indicates whether data previously associated with the acknowledgement process is not to form the basis of a transmission using the third uplink communications resources, and
in response to determining, based on the first uplink communications resources, that the second uplink communications resources cannot be used for the transmission of the second data, to transmit the second data using the third uplink communications resources irrespective of the new data indicator.

30.-31. (canceled)
